(19) United States
(12) Patent Application Publication
(10) Pub. No.: US 2020/0218404 A1
(43) Pub. Date: Jul. 9, 2020

(54) VEHICLE INSTRUMENT CLUSTER CONSILIDATION SYSTEM

(71) Applicant: SF Motors, Inc., Santa Clara, CA (US)

(72) Inventors: Jaime Camhi, Santa Clara, CA (US); Avery Jutkowitz, Santa Clara, CA (US); Hakuei Huang, Santa Clara, CA (US); Nischitha Mallikarjuna, Santa Clara, CA (US); Ajay Bandi, Santa Clara, CA (US); Joshua Hoffman, Santa Clara, CA (US); Xiaoran Yao, Santa Clara, CA (US)

(21) Appl. No.: 16/243,335

(22) Filed: Jan. 9, 2019

(51) Int. Cl. G06F 3/0482; B60K 35/00; G06F 3/0484

(52) U.S. Cl. CPC G06F 3/0482; B60K 35/00; B60K 2350/1076; B60K 2350/352; G06F 3/04847

(57) ABSTRACT

Provided herein is a vehicle instrument cluster consolidation system. The consolidated instrument cluster includes a vehicle based data processing system communicatively coupled with a display module. The display module can include multiple windows to display a plurality of menu items. The vehicle based data processing system communicatively can couple with the display module, input devices, and sliders to interact with the menu items provided within the multiple windows. The vehicle based data processing system can receive a motion input indicating a direction to relocate the plurality of menu items within the multiple windows. The vehicle based data processing system to, responsive to the motion input, relocate a first menu item from the center window to a second offset window and relocate a second menu item from a first offset window to the center window.

### BACKGROUND

Vehicles can include different information systems to provide information related to the vehicle.

### SUMMARY

At least one aspect is directed to a vehicle instrument cluster consolidation system. The vehicle instrument cluster consolidation system includes a vehicle based data processing system communicatively coupled with a display module. The display module can include multiple windows to display a plurality of menu items. Each of the multiple windows can display at least one menu item of the plurality of menu items. The plurality of menu items can include at least one of a climate control menu, an entertainment menu, an autonomous drive menu, a navigation menu, and a phone menu. The multiple windows can include a center window. Each of the multiple windows can be at least partially visible within a vehicle. The center window of the multiple windows can have greater visibility than other multiple windows of the display module. The vehicle instrument cluster consolidation system can include a first input device, a second input device, a first slider, and a second slider. The vehicle based data processing system communicatively can couple with the display module, first input device, second input device, first slider, and second slider. The vehicle based data processing system to display a first menu item of the plurality of menu items in the center window and a second menu item of the plurality of menu items in a first offset window of the multiple windows. The vehicle based data processing system to receive a first motion input through the first slider. The first motion input can indicate a first direction to relocate the plurality of menu items within the multiple windows. The vehicle based data processing system to, responsive to the first motion input, identify a first instruction corresponding to the first motion input to relocate the first menu item in the first direction from the center window to a second offset window. The vehicle based data processing system to, responsive to the first motion input, identify a second instruction corresponding to the first motion input to relocate the second menu item in the first direction from the first offset window to the center window. The vehicle based data processing system to, responsive to the first instruction, reduce a size of the first menu item and relocate the first menu item from the center window to a second offset window of the multiple windows in the first direction. The vehicle based data processing system to, responsive to the second instruction, increase a size of the second menu item and relocate the second menu item from the first offset window to the center window in the first direction.

At least one aspect is directed to a method of consolidating vehicle instrument clusters of a vehicle. The method can include displaying, by a vehicle based data processing system, a plurality of menu items within multiple windows of a display module. The multiple windows can include a center window. Each of the multiple windows can display at least one menu item of the plurality of menu items. Each of the multiple windows can be at least partially visible within the vehicle. The center window of the multiple windows can have a greater visibility than other multiple windows of the display module. The method can include generating, by the vehicle based data processing system, the plurality of menu items including at least one of a climate control menu, an entertainment menu, an autonomous drive menu, a navigation menu, and a phone menu. The method can include communicatively coupling a first input device, a second input device, a first slider, and a second slider with the vehicle based data processing system. The method can include displaying, by the vehicle based data processing system, a first menu item of the plurality of menu items in the center window. The method can include displaying, by the vehicle based data processing system, a second menu item of the plurality of menu items in a first offset window of the multiple windows. The method can include receiving, by the vehicle based data processing system, a first motion input through the first slider. The first motion input can indicate a first direction to relocate the plurality of menu items within the multiple windows. The method can include, responsive to the first motion input, identifying, by the vehicle based data processing system, a first instruction corresponding to the first motion input to relocate the first menu item in the first direction from the center window to a second offset window. The method can include, responsive to the first motion input, identifying, by the vehicle based data processing system, a second instruction corresponding to the first motion input to relocate the second menu item in the first direction from the first offset window to the center window. The method can include, responsive to the first instruction, reducing, by the vehicle based data processing system, a size of the first menu item responsive to the first motion input and relocating the first menu item from the center window to a second offset window of the multiple windows. The method can include responsive to the second instruction increasing, by the vehicle based data processing system, a size of the second menu item responsive to the first motion input and relocating the second menu item from the first offset window to the center window.

At least one aspect is directed to a method. The method can provide a vehicle instrument cluster consolidation system. The vehicle instrument cluster consolidation system includes a vehicle based data processing system communicatively coupled with a display module. The display module can include multiple windows to display a plurality of menu items. Each of the multiple windows can display at least one menu item of the plurality of menu items. The plurality of menu items can include at least one of a climate control menu, an entertainment menu, an autonomous drive menu, a navigation menu, and a phone menu. The multiple windows can include a center window. Each of the multiple windows can be at least partially visible within a vehicle. The center window of the multiple windows can have greater visibility than other multiple windows of the display module. The vehicle instrument cluster consolidation system can include a first input device, a second input device, a first slider, and a second slider. The vehicle based data processing system communicatively can couple with the display module, first input device, second input device, first slider, and second slider. The vehicle based data processing system to display a first menu item of the plurality of menu items in the center window and a second menu item of the plurality of menu items in a first offset window of the multiple windows. The vehicle based data processing system to receive a first motion input through the first slider. The first motion input can indicate a first direction to relocate the plurality of menu items within the multiple windows. The vehicle based data processing system to, responsive to the first motion input, identify a first instruction corresponding to the first motion input to relocate the first menu item in the first direction from the center window to a second offset window. The vehicle based data processing system to, responsive to the first motion input, identify a second instruction corresponding to the first motion input to relocate the second menu item in the first direction from the first offset window to the center window. The vehicle based data processing system to, responsive to the first instruction, reduce a size of the first menu item and relocate the first menu item from the center window to a second offset window of the multiple windows in the first direction. The vehicle based data processing system to, responsive to the second instruction, increase a size of the second menu item and relocate the second menu item from the first offset window to the center window in the first direction.

At least one aspect is directed to an electric vehicle. The electric vehicle can include a vehicle instrument cluster consolidation system. The vehicle instrument cluster consolidation system includes a vehicle based data processing system communicatively coupled with a display module. The display module can include multiple windows to display a plurality of menu items. Each of the multiple windows can display at least one menu item of the plurality of menu items. The plurality of menu items can include at least one of a climate control menu, an entertainment menu, an autonomous drive menu, a navigation menu, and a phone menu. The multiple windows can include a center window. Each of the multiple windows can be at least partially visible within a vehicle. The center window of the multiple windows can have greater visibility than other multiple windows of the display module. The vehicle instrument cluster consolidation system can include a first input device, a second input device, a first slider, and a second slider. The vehicle based data processing system communicatively can couple with the display module, first input device, second input device, first slider, and second slider. The vehicle based data processing system to display a first menu item of the plurality of menu items in the center window and a second menu item of the plurality of menu items in a first offset window of the multiple windows. The vehicle based data processing system to receive a first motion input through the first slider. The first motion input can indicate a first direction to relocate the plurality of menu items within the multiple windows. The vehicle based data processing system to, responsive to the first motion input, identify a first instruction corresponding to the first motion input to relocate the first menu item in the first direction from the center window to a second offset window. The vehicle based data processing system to, responsive to the first motion input, identify a second instruction corresponding to the first motion input to relocate the second menu item in the first direction from the first offset window to the center window. The vehicle based data processing system to, responsive to the first instruction, reduce a size of the first menu item and relocate the first menu item from the center window to a second offset window of the multiple windows in the first direction. The vehicle based data processing system to, responsive to the second instruction, increase a size of the second menu item and relocate the second menu item from the first offset window to the center window in the first direction.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a vehicle instrument cluster consolidation system within a vehicle, according to an illustrative implementation;

FIG. 2 is a block diagram depicting a vehicle instrument cluster consolidation system provided within a steering wheel of a vehicle, according to an illustrative implementation;

FIG. 3 is a block diagram of a display module having multiple windows for a vehicle instrument cluster consolidation system, according to an illustrative implementation;

FIG. 4 is a block diagram showing the transition of content within a center window of a display module for a vehicle instrument cluster consolidation system, according to an illustrative implementation;

FIG. 5 is a flow diagram depicting an example method of providing a vehicle instrument cluster consolidation system for a vehicle;

FIG. 6 is a flow diagram depicting an example method of providing a vehicle instrument cluster consolidation system for a vehicle; and

FIG. 7 is a block diagram illustrating an architecture for a computer system that can be employed to implement elements of the systems and methods described and illustrated herein, including, for example, the system depicted in FIGS. 1-4, and the methods depicted in FIGS. 5-6.

### DETAILED DESCRIPTION

Following below are more detailed descriptions of various concepts related to, and implementations of vehicle instrument cluster consolidation systems for vehicles, such as electric vehicles, including hybrid vehicles. The various concepts introduced above and discussed in greater detail below can be implemented in any of numerous ways. The consolidated instrument cluster can include multiple input devices to provide an interface for a user of a vehicle (e.g., driver, passenger) to interact with different systems or applications of the vehicle from a consolidated instrument cluster. For example, the consolidated instrument cluster can combine processing power of multiple systems into a single system having a single display to efficiently manage the allocation of computer resources within the vehicle.

The consolidated instrument cluster can include or otherwise couple with a controls interface for a vehicle (e.g., electric vehicle) and a display module having multiple windows to allow a user of the vehicle to interact with different systems or applications of the vehicle from a single consolidated system. For example, the consolidated instrument cluster can consolidate or combine different processors and logic from multiple systems or components of a vehicle into a single system to more efficiently manage computer resources of the respective vehicle. The consolidated instrument cluster can couple with a single display module having multiple windows to consolidate hardware resources of the respective vehicle, which can reduce the weight of the vehicle, leading to increased vehicle range. Further, instead of multiple different displays, each of which provide content corresponding to different systems of the vehicle, the consolidated instrument clusters as described herein can provide a single system with a single display module to provide content from each of the different systems of the vehicle. Thus, separate displays, panels, processors, or logic can be eliminated or reduced to more efficiently manage the computer resources (e.g., software, hardware) of the respective vehicle. The consolidated instrument cluster can improve computer resource allocation by eliminating or reducing the amount of separate and distinct processors and hardware elements for vehicle systems that may be used sparingly. Thus, conserving and efficiently allocating computer resources of the respective vehicle through the consolidated instrument cluster. The consolidated instrument cluster can include multiple input devices to interact with content provided within the display module. For example, the input devices can be provided in a common location such that the user of the vehicle can interact with the different systems or applications of the vehicle from a single vantage point. This can help to conserve computer resources, and may avoid or eliminate different systems of the vehicle each having independent input devices for a user of the vehicle to interact with the respective system of the vehicle.

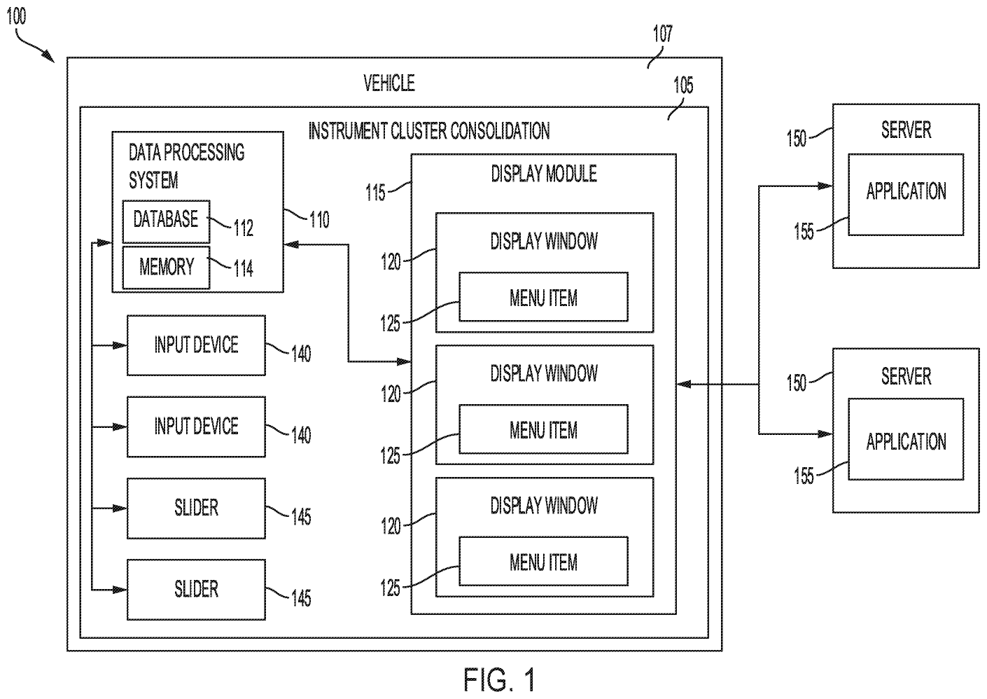

FIG. 1, among others, depicts a view 100 of a block diagram of a vehicle instrument cluster consolidated system 105 for a vehicle 107. The vehicle 107 can include a configuration, arrangement or network of electrical, electronic, mechanical or electromechanical devices within a vehicle of any type. The vehicle 107 can include automobiles, cars, trucks, passenger vehicles, industrial vehicles, motorcycles, and other transport vehicles. The vehicle 107 can include electric vehicles, electric automobiles, cars, motorcycles, scooters, passenger vehicles, passenger or commercial trucks, and other vehicles such as sea or air transport vehicles, planes, helicopters, submarines, boats, or drones. The vehicle 107 can be fully autonomous, partially autonomous, or unmanned. Thus, the vehicle 107 can include an autonomous, semi-autonomous, or non-autonomous human operated vehicle. The vehicle 107 can include a hybrid vehicle that operates from on-board electric sources and from gasoline or other power sources. The vehicle 107 can include an electric vehicle (EVs), hybrid vehicle, fossil fuel vehicle, a car, a truck, motorcycles, scooters, passenger vehicles, passenger or commercial trucks, and other vehicles such as sea or air transport vehicles, planes, helicopters, submarines, boats, or drones. The EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

The consolidated instrument cluster 105 can couple multiple different systems or applications executing within, executing on the vehicle or external to the vehicle (e.g., third party servers) within a single system to conserve and more efficiently allocate computer resources of the respective vehicle through the consolidated instrument cluster 105. The consolidated instrument cluster 105 can include a plurality of display windows 120 with a center or middle display window 102 providing an interface window for a user of the vehicle 107 to interact with the different systems or applications of the vehicle 107 from the single consolidated instrument cluster 105. For example, the user can scan through different systems or applications of the vehicle 107 by modifying the content provided within the center display window 120. The content can be modified using the multiple input devices 140 provided within or coupled with the consolidated instrument cluster 105. Thus, the consolidated instrument cluster 105 as described herein can reduce or eliminate the need for any specific button layout, independent hardware, independent software for each of the different systems of the vehicle 107. The consolidated instrument cluster 105 can provide a consistent and easily accessible control interface for any context the user may want to interface with in the vehicle 107 directly from, for example but not limited to, a steering wheel of the vehicle 107.

The consolidated instrument cluster 105 can include a vehicle based data processing system (e.g., DPS) 110. The vehicle based data processing system 110 can generate control signals to modify content or menu items displayed within each of the window 120 of the display module 115. For example, the vehicle based data processing system 110 can receive an input from a user of the vehicle 107 and generate control signals, responsive to the input, to modify content or menu items displayed within each of the window 120 of the display module 115. The vehicle based data processing system 110 can consolidate the display of the plurality of menu items 125 into the single display module 115. For example, the menu items 125 can be provided within the different windows 120 of the display module 115 to consolidate and provide the display of the menu items in a single interface. The vehicle based data processing system 110 can include a database 112 and a memory 114. The vehicle based data processing system 110 can be implemented using hardware or a combination of software and hardware. For example, each component of the vehicle based data processing system 110 can include logical circuitry (e.g., a central processing unit or CPU) that responses to and processes instructions fetched from a memory unit (e.g., memory 114). Each component of the vehicle based data processing system 110 can include or use a microprocessor or a multi-core processor. A multi-core processor can include two or more processing units on a single computing component. Each component of the vehicle based data processing system 110 can be based on any of these processors, or any other processor capable of operating as described herein. Each processor can utilize instruction level parallelism, thread level parallelism, or different levels of cache, for example.

For example, the vehicle based data processing system 110 can include at least one logic device such as a computing device or server having at least one processor to communicate via a network with one or more systems of the vehicle 107. The components and elements (e.g., database 112, memory 114) of the vehicle based data processing system 110 can be separate components, a single component, or part of the vehicle based data processing system 110. For example, the database 112 and the memory 114) can include combinations of hardware and software, such as one or more processors configured to initiate stop commands, initiate motion commands, and transmit or receive timing data, for example.

The database 112 can include a structured set of data stored for the vehicle based data processing system 110. The database 112 can couple with the memory 114 to store and retrieve, such as, menu items (e.g., menu items 125, display window properties (e.g., display windows 120), motion inputs, direction inputs, vehicle information, command instructions, vehicle status information, environmental information within or external to the vehicle, road status or road condition information, vehicle location information or other information during execution of instructions by the vehicle based data processing system 110. The memory 114 can include a random access memory (RAM) or other dynamic storage device, coupled with the vehicle based data processing system 110 for storing information, and instructions to be executed by the vehicle based data processing system 110. The memory 114 can be used for storing menu items (e.g., menu items 125, display window properties (e.g., display windows 120), motion inputs, direction inputs, vehicle information, command instructions, vehicle status information, environmental information within or external to the vehicle, road status or road condition information, vehicle location information or other information during execution of instructions by the vehicle based data processing system 110. The memory 114 can include at least one read only memory (ROM) or other static storage device coupled with the vehicle based data processing system 110 for storing static information and instructions for the vehicle based data processing system 110. The memory 114 can include a storage device, such as a solid state device, magnetic disk or optical disk, coupled with the vehicle based data processing system 110 to persistently store information and instructions.

The consolidated instrument cluster 105 can include a display module 115 having a plurality of windows 120 to provide a plurality of menu items 125. The display module 115 and each of the plurality of windows 120 can include a touch screen. For example, the display module 115 and each of the plurality of windows 120 can receive a contact or touch input via a screen of the respective window 120 and generate a signal corresponding to the contact input. Thus, display module 115 and each of the plurality of windows 120 can provide an interface for a user to interact with through contact. Each of the multiple windows 120 can display at least one menu item 125 of the plurality of menu items 125. The menu items 125 can include data structures stored in a database (e.g., database 112) of the consolidated instrument cluster 105 or a database separate from but communicatively coupled with the consolidated instrument cluster 105. The plurality of menu items 125 can include, for example, at least one of a climate control menu, an entertainment menu, an autonomous drive menu, a navigation menu, and a phone menu. The menu items 125 can correspond to any system, component or element of the vehicle 107 or any system, component or element coupled with the vehicle 107 (e.g., cell phone, computing device, electronic key). The display module 115 can provide a visual output or an audio output from the vehicle based data processing system 110, the vehicle 107 or other forms of computing device content to a user of the vehicle 107 through the plurality of windows 120. For example, the display module 115 can provide a visual feedback output from the vehicle based data processing system 110 to a user of the vehicle 107 through the plurality of windows 120. The windows 120 can include an electronic device for the visual presentation of data, such as but not limited to, menu items 125. The windows 120 (e.g., display windows) can include an interface, a screen, a digital window, or display device to provide a visual display to a user of the vehicle 107. The windows 120 can correspond to portions of the display module 115 generated by the vehicle based data processing system 110.

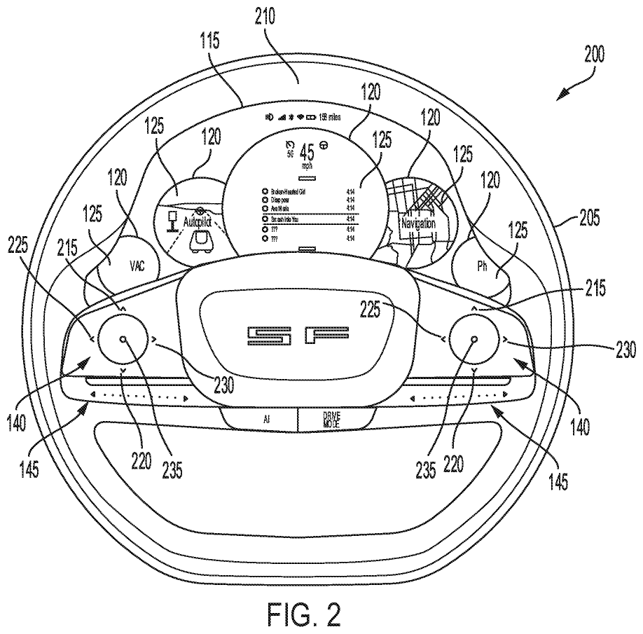

The dimensions of the windows 120 can vary based at least in part on a location within a vehicle 107 that the windows 120 are disposed or provided. Each of the windows 120 can have the same dimensions. One or more of the windows 120 can have different (e.g., greater, less than) dimensions that one or more other windows 120. The dimensions of the windows 120 can be dynamically modified by the vehicle based data processing system 110. For example, the vehicle based data processing system 110 can generate the windows 120 for the display module 115. The vehicle based data processing system 110 can determine a number of windows 120 to provide within the display module 115 based in part on the dimensions of the display module 115 or a user of the vehicle. The vehicle based data processing system 110 can determine dimensions (e.g., diameter, radius, length, width) of the windows 120. The vehicle based data processing system 110 can determine a number of pixels within the display module 115 to allocate to each of the windows 120. The vehicle based data processing system 110 can determine a position for each of the windows 120 within the display module 115. The vehicle based data processing system 110 can determine which window 120 can be a center window 120 and which windows can be an offset window 120. For example, the display module 115 can include five windows (as illustrated in FIG. 2) and a center window 120, a first offset window 120, a second offset window 120, a third offset window 120, and fourth offset window 120. The center window 120 can be disposed between the second offset window 120 (e.g., offset to the left of the center window) and the third offset window 120 (e.g., offset to the right of the center window). The second offset window 120 can be positioned between the first offset window 120 and the center window 120. The third offset window 120 can be positioned between the center window 120 and the fourth offset window 120. The vehicle based data processing system 110 can position each of the center window 120, the first offset window 120, the second offset window 120, the third offset window 120, or the fourth offset window 120 within the display module 115.

The vehicle based data processing system 110 can determine the dimensions for the display module 115 and the windows 120 based in part on a state. For example, the vehicle based data processing system 110 can generate the display module 115 and windows 120 in a normal state or a modified state. The modified state can include a zoomed in or maximized center window 120 and zoomed out or minimized offset windows 120. The modified state can include a zoomed out or minimized center window 120 and zoomed in or maximized offset windows 120. In the normal state, the vehicle based data processing system 110 can generate the display module 115 having dimensions in the range of 1700 to 1800 pixels by 800 to 900 pixels (e.g., 1730 pixels by 820 pixels). The dimensions of the display module 115 can vary within or outside this range. The vehicle based data processing system 110 can generate the center window 120 having dimensions in the range of 800 to 900 pixels by 500 to 600 pixels (e.g., 875 pixels by 534 pixels). The dimensions of the center window 120 can vary within or outside this range. The vehicle based data processing system 110 can generate the offset windows 120 having dimensions in the range of 300 to 400 pixels by 300 to 400 pixels (e.g., 340 pixels by 340 pixels). The dimensions of the offset windows 120 can vary within or outside this range. The vehicle based data processing system 110 can generate an offset window 120 to show at least one of: a speed of the vehicle 107, a drive mode of the vehicle 107, and a status of the vehicle 107. For example, the vehicle based data processing system 110 can generate the speed offset window 120 having dimensions in the range of 200 to 300 pixels by 50 to 150 pixels (e.g., 255 pixels by 75 pixels). The dimensions of the speed offset window 120 can vary within or outside this range. The vehicle based data processing system 110 can generate the drive mode offset window 120 having dimensions in the range of 350 to 450 pixels by 20 to 150 pixels (e.g., 400 pixels by 60 pixels). The dimensions of the drive mode offset window 120 can vary within or outside this range. The vehicle based data processing system 110 can generate the status offset window 120 having dimensions in the range of 700 to 800 pixels by 2 to 150 pixels (e.g., 742 pixels by 35 pixels). The dimensions of the status offset window 120 can vary within or outside this range.

In the modified state, the vehicle based data processing system 110 can generate the display module 115 having dimensions in the range of 1700 to 1800 pixels by 800 to 900 pixels (e.g., 1730 pixels by 820 pixels). The dimensions of the display module 115 can vary within or outside this range. The vehicle based data processing system 110 can generate the center window 120 having dimensions in the range of 1700 to 1800 pixels by 800 to 900 pixels (e.g., 1730 pixels by 820 pixels). The dimensions of the center window 120 can vary within or outside this range. The vehicle based data processing system 110 can generate the offset windows 120 having dimensions in the range of 200 to 300 pixels by 100 to 200 pixels (e.g., 220 pixels by 160 pixels). The dimensions of the offset windows 120 can vary within or outside this range. The vehicle based data processing system 110 can generate an offset window 120 to show at least one of: a speed of the vehicle 107, a drive mode of the vehicle 107, and a status of the vehicle 107. For example, the vehicle based data processing system 110 can generate the speed offset window 120 having dimensions in the range of 200 to 300 pixels by 50 to 150 pixels (e.g., 255 pixels by 75 pixels). The dimensions of the speed offset window 120 can vary within or outside this range. The vehicle based data processing system 110 can generate the drive mode offset window 120 having dimensions in the range of 350 to 450 pixels by 20 to 150 pixels (e.g., 400 pixels by 60 pixels). The dimensions of the drive mode offset window 120 can vary within or outside this range. The vehicle based data processing system 110 can generate the status offset window 120 having dimensions in the range of 700 to 800 pixels by 2 to 150 pixels (e.g., 742 pixels by 35 pixels). The dimensions of the status offset window 120 can vary within or outside this range.

The display module 115 can be disposed within or provided within various components of the vehicle 107. For example, but not limited to, the display module 115 and the plurality of windows 120 can be disposed within or provided within a dashboard, a console, a steering wheel, or a seat (e.g., head rest, back portion) of the vehicle 107. The display module 115 can include two or more windows 120. The display module 115 can include a single window 120. The display module 115 can provide a visual or audio output from the vehicle based data processing system 110, the vehicle 107 or other forms of computing device content to a user of the vehicle.

The consolidated instrument cluster 105 can include or couple with at least one input device 140. The input device 140 can include a device, a human interface device, a computing device or computing element to receive and provide data and control signals to the vehicle based data processing system 110. The input device 140 can generate the control signal responsive to, but not limited to, a physical motion, mechanical motion, or audio input. For example, the input device 140 can generate a control signal responsive to contact (e.g., physical contact) with a surface of the input device 140. The input device 140 can generate the control signal responsive to, but not limited to, a touching, a pressing, a swipe motion or other forms of contact with the surface of the input device 140. The contact can include discrete contact or continuous contact. The input device 140 can include a keypad, a layout of buttons or group of buttons. For example, the buttons can generate a signal responsive to at least one of a contact input, a physical motion input, a mechanical motion input, or an audio input. The input device 140 can include two or more buttons. The input device 140 can include a single button. The buttons can include mechanical buttons (e.g., spring based buttons), digital buttons or virtual buttons.

The consolidated instrument cluster 105 can include or couple with at least one slider 145. The slider 145 can include a device, a human interface device, a computing device or computing element to receive and provide data and control signals to the vehicle based data processing system 110. The slider 145 can generate the control signal responsive to, but not limited to, a physical motion, mechanical motion, or audio input. For example, the slider 145 can generate a control signal responsive to contact (e.g., physical contact) with a surface of the respective slider 145. The slider 145 can generate the control signal responsive to, but not limited to, a touching, a pressing, a swipe motion or other forms of contact with the surface of the respective slider 145. The contact can include discrete contact or continuous contact. The slider 145 can generate control signals indicating a motion or a direction of a physical input. For example, the slider 145 can generate controls signals representing the direction of a swipe motion (e.g., left, right, up, down) that corresponds to the direction of the swipe motion along the surface of the respective slider 145.

The consolidated instrument cluster 105 can couple with at least one server 150 that hosts or provides at least one application 155. The servers 150 can include remote servers or third party servers executing external to the vehicle 107 or the vehicle based data processing system 110. For example, the servers 150 may include an application delivery system for delivering an application 155, a computing environment, and/or data files to the vehicle based data processing system 110. The servers 150 can include HTTP servers or application servers. The applications 155 may include web content, HTTP content or resources provided by or hosted by the servers 150. For example, the applications 155 may include network applications that are served from and/or hosted on the servers 150. The applications 155 can include an application hosted on at least one server 150 accessed by the vehicle based data processing system 110 via a network. The applications 155 can include, but not limited to, a web application, a desktop application, remote-hosted application, a virtual application, a mobile application, an HDX application, a local application, or a native application (e.g., native to the vehicle based data processing system 110 or vehicle 107). The vehicle based data processing system 110 and the servers 150 can be communicatively coupled through a network, such as but not limited to, a public network, a wide area network (WAN) or the Internet. The network may be a private network such as a local area network (LAN) or a company Intranet. The network may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

FIG. 2, among others, depicts a view 200 of a steering wheel 205 and a dashboard 210 of a vehicle 107. A display module 115 can be provided within the dashboard 210. The dashboard 210 can be separate from the steering wheel 205. The dashboard 210 can be a component of the steering wheel 205. The steering wheel 205 can include a first input device 140, a second input device 140, a first slider 145, and a second slider 145. The first input device 140, the second input device 140, the first slider 145, and the second slider 145 can be disposed on the steering wheel 205 to provide an interface for a user of the vehicle 107 to interact with the content provided within the display module 115 by the vehicle based data processing system 110.

The display module 115 can include a plurality of windows 120. For example, and as depicted in FIG. 2, the display module 115 can include a first offset window 120, a second offset window 120, a center window 120, a third offset window 120, and a fourth offset window 120. The center window 120 can be disposed between the second offset window 120 and the third offset window 120. The second offset window 120 can be disposed between the first offset window 120 and the center window 120. The third offset window 120 can be disposed between the center window 120 and the fourth offset window 120. At least one input device 140 can be couple with or be disposed on the steering wheel 205 to interact with menu items 125 provided within the windows 120. In FIG. 2, a first input device 140 and a second input device 140 can couple with or be disposed on the steering wheel 205. For example, the first input device 140 can be located at a first position (e.g., left position, left side) on the steering wheel 205 and the second input device 140 can be located at a second position (e.g., right position, right side) on the steering wheel 205. The first location can be different from the second location. The first location can be an opposite location from the second location. The locations or positions of the input devices 140 can be selected based at least in part on ease of access for a user of the vehicle 107. For example, the locations or positions of the input devices 140 can be selected based at least in part on a position of a user's hand on the steering wheel 205 when the user is operating the vehicle 107 or within the vehicle 107. The locations or positions of the input devices 140 can be selected such that the user of the vehicle 107 can reach or access both the first input device 140 with a first hand and the second input device 140 with a second hand without changing position within the vehicle 107.

The input devices 140 can couple (e.g., communicatively couple) with the vehicle based data processing system 110 to modify a position of content of a menu item 125 provided within at least one window 120 (e.g., center window) of the display module 115, responsive to a directional input received via the respective input device 140. The input devices 140 can include at least one direction input to modify a position of content of a menu item 125 provided within at least one window 120. For example, the first input device 140 and the second input device 140 can each include multiple directional inputs. Each of the multiple directional inputs can correspond to a different direction. For example, the first input device 140 can include an up input 215, a down input 220, a left input 225, a right input 230, and a center input 235. The second input device 140 can include an up input 215, a down input 220, a left input 225, a right input 230, and a center input 235. The directional inputs can be arranged or positioned based in part on a direction the respective directional input corresponds to. For example, the up input 215 can be positioned in an up position or at a higher level as compared to the other directional inputs forming the same input device 140. The down input 220 can be positioned in a down position or at a lower level as compared to the other directional input s forming the same input device 140. The left input 225 can be positioned in a left position as compared to the other directional input s forming the same input device 140. The right input 230 can be positioned in a right position as compared to the other directional input s forming the same input device 140. The center input 235 can be positioned in a center position as compared to the other directional input s forming the same input device 140.

Each of the multiple directional inputs can generate at least one directional signal to interact with at least one menu item 125 provided within the center window 120 of the display module 115. The directional inputs can be provided to the vehicle based data processing system 110. The direction inputs can correspond to an interaction with the menu items 125 displayed within the windows 120 of the display module 115. For example, the up input 215 can generate an up signal to scroll content or menu items 125 displayed within the center window 120 in an up direction. The up input 215 can generate the up signal responsive to contact (e.g., pressing, pushing, with a surface of the up input 215. The down input 220 can generate a down signal to scroll content or menu items 125 displayed within the center window 120 in a down direction. The down input 220 can generate the down signal responsive to contact (e.g., pressing, pushing) with a surface of the down input 220. The left input 225 can generate a left signal to scroll content or menu items 125 displayed within the center window 120 in a left direction. The left input 225 can generate the left signal responsive to contact (e.g., pressing, pushing) with a surface of the left input 225. The right input 230 can generate a right signal to scroll content or menu items 125 displayed within the center window 120 in a right direction. The right input 230 can generate the right signal responsive to contact (e.g., pressing, pushing) with a surface of the right input 230. The center input 235 can be used to select content or menu items 125 displayed within the center window 120. For example, the center input 235 can generate a selection signal to select content or menu items 125 displayed within the center window 120. The selection signal can activate an application corresponding to the menu item 125 displayed within the center window 120. For example, if the menu item 125 corresponds to a music selection, the selection signal can activate a music application for the vehicle 107 or play a song corresponding to the menu item 125 displayed within the center window 120. The center input 235 can generate the selection signal responsive to contact (e.g., pressing, pushing) with a surface of the center input 235.

The directional signals can include a time value corresponding to a length of contact with the respective input device 140 by a user of the vehicle 107. For example, contact longer than a time threshold may indicate a double relocation (e.g., scroll content of menu items 125 at least two positions within the window 120 in a direction of the respective directional input). A continuous contact may indicate a continuous relocation of the content of the menu items 125 within the window 120 in a direction of the corresponding directional input. For example, a user of the vehicle 107 may hold a left input slider down or make continuous contact with the left input of an input device 140. During the continuous contact, the input device 140 can generate a directional signal to the vehicle based data processing system 110 to continually keep scrolling the content of the menu item 125 in a direction (e.g., left direction) of the directional input until the contact with the left input stops.

At least one slider 145 can couple with or be disposed on the steering wheel 205. In FIG. 2, a first slider 145 and a second slider 145 can couple with or be disposed on the steering wheel 205. The first slider 145 can be located at a first position (e.g., left position, left side) on the steering wheel 205 and the second slider 145 can be located at a second position (e.g., right position, right side) on the steering wheel 205. The first location can be different from the second location. The first location can be an opposite location from the second location. The locations or positions of the sliders 145 can be selected based at least in part on a location of the input devices 140. For example, the first slider 145 can be positioned adjacent to, next to or proximate to the first input device 140. In FIG. 2, the first slider 145 is aligned with the first input device 140 and positioned under the down input 220 of the first input device 140. The first slider 145 can be positioned proximate to the first input device 140 such that a user of the vehicle 107 can access (e.g., reach) or interact with the first input device 140 and the first slider 145 without changing the position of the user of the vehicle 107. The second slider 145 can be positioned adjacent to, next to or proximate to the second input device 140. In FIG. 2, the second slider 145 is aligned with the second input device 140 and positioned under the down input 220 of the second input device 140. The second slider 145 can be positioned proximate to the second input device 140 such that a user of the vehicle 107 can access (e.g., reach) or interact with the second input device 140 and the second slider 145 without changing the position of the user of the vehicle 107. Thus, the locations or positions of the sliders 145 can be selected based at least in part on ease of access for a user of the vehicle 107. For example, the locations or positions of the sliders 145 can be selected based at least in part on a position of a user's hand on the steering wheel 205 when the user is operating the vehicle 107 or within the vehicle 107. The locations or positions of the sliders 145 can be selected such that the user of the vehicle 107 can reach or access both the first slider 145 with a first hand and the second slider 145 with a second hand without changing position within the vehicle 107.

The sliders 145 can receive a motion input through, for example, contact with a surface of the respective slider 145. The motion input may include, but not limited to, a swiping motion, a slide motion, or a pressing motion. For example, the motion input may include, but not limited to, a swiping motion, a slide motion, or a pressing motion applied to a surface of the respective slider 145. The sliders 145 can generate a motion signal corresponding to a direction of the motion or contact with the surface of the respective slider 145. The sliders 145 can couple with the vehicle based data processing system 110 to provide the motion signal to the vehicle based data processing system 110. The motion signal can include instructions for the vehicle based data processing system 110 to move, relocate or otherwise modify the menu items 125 displayed within the windows 120 of the display module 115. For example, the first slider 145 can receive a first motion input and generate a first motion signal having instructions to scroll the menu items 125 displayed within the windows 120 of the display module 115 in a direction of the received motion. The sliders 145 can, responsive to a swipe in a left direction, can generate a motion signal to scroll the menu items 125 at least one window 120 to the left. The sliders 145 can, responsive to a swipe in a right direction, can generate a motion signal to scroll the menu items 125 at least one window 120 to the right. The motion signal can include a time value corresponding to a length of contact with the respective slider 145 by a user of the vehicle 107. For example, a swipe motion longer than a time threshold may indicate a double relocation (e.g., move menu items 125 at least two windows 120 in a direction of the respective motion input). A continuous contact may indicate a continuous relocation of the menu items 125 within the windows 120 in a direction of the corresponding motion. For example, a user of the vehicle 107 may hold a slider down or make continuous contact with the respective slider 145. During the continuous contact, the slider 145 can generate a motion signal to the vehicle based data processing system 110 to continually keep relocating the menu items 125 in a direction of the motion signal until the contact with the slider 145 stops. Thus, the motion signal can shuffle the menu items 125 within the windows 120 until the contact with the slider 145 stops.

The sliders 145 can couple (e.g., communicatively couple) with the vehicle based data processing system 110 to modify a position of menu items 125 provided within the multiple windows 120 of the display module 115, responsive to a motion input received via the respective slider 145. For example, the first slider 145 can couple with the vehicle based data processing system 110 to modify menu items 125 provided within the multiple windows 120 of the display module 115, responsive to a first motion input received via the first slider 145. The second slider 145 can couple with the vehicle based data processing system 110 to modify menu items 125 provided within the multiple windows 120 of the display module 115, responsive to a second motion input received via the second slider 145. The first motion input can correspond to a different direction from the second motion input.

For example, the first slider 145 can receive a first motion input and generate a first motion signal having instructions to scroll the menu items 125 displayed within the windows 120 of the display module 115 in a direction corresponding to the received motion. The vehicle based data processing system 110 can receive the first motion signal and reduce a size of a first menu item 125 responsive to the first motion input. The vehicle based data processing system 110 can reduce the size of the first menu item 125 based in part on the size of the second offset window 120 or third offset window 120. For example, the vehicle based data processing system 110 can generate instructions to reduce the size of the first menu item 125 by 10% or by 10% relative to the size of the second offset window 120 or the third offset window 120. The vehicle based data processing system 110 can execute the instructions to reduce the size of the first menu item 125 by 10% or by 10% relative to the size of the second offset window 120 or the third offset window 120. The vehicle based data processing system 110 can reduce the size of the first menu item 125 in a range from 5% to 75%. The vehicle based data processing system 110 can move the first menu item 125 from the center window 120 to the second offset window 120 or the third offset window 120. For example, the vehicle based data processing system 110 can move the first menu item 125 from the center window 120 to the second offset window 120 in response to a left motion input. The vehicle based data processing system 110 can move the first menu item 125 from the center window 120 to the third offset window 120 in response to a right motion input. The vehicle based data processing system 110 can increase a size of a second menu item 125 responsive to the motion input. The vehicle based data processing system 110 can increase the size of the second menu item 125 based in part on the size of the center window 120. For example, the vehicle based data processing system 110 can generate instructions to increase the size of the second menu item 125 by 10% or by 10% relative to the size of the center window 120. The vehicle based data processing system 110 can execute the instructions to increase the size of the second menu item 125 by 10% or by 10% relative to the size of the center window 120. The vehicle based data processing system 110 can increase the size of the second menu item 125 in a range from 5% to 75%. The vehicle based data processing system 110 can move the second menu item 125 from an offset window 120 (or different window) to the center window 120. For example, the vehicle based data processing system 110 can move the second menu item 125 from the third offset window 120 to the center window 120 in response to a left motion input. The vehicle based data processing system 110 can move the second menu item 125 from the second offset window 120 to the center window 120 in response to a right motion input.

The second slider 145 can receive a second motion input and generate a second motion signal having instructions to scroll the menu items 125 displayed within the windows 120 of the display module 115 in a direction corresponding to the received motion. The vehicle based data processing system 110 can receive the second motion signal and reduce a size of the second menu item 125 responsive to the second motion input. The vehicle based data processing system 110 can reduce the size of the second menu item 125 based in part on the size of the second offset window 120. For example, the vehicle based data processing system 110 can generate instructions to reduce the size of the second menu item 125 by 10% or by 10% relative to the size of the second offset window 120. The vehicle based data processing system 110 can execute the instructions to reduce the size of the second menu item 125 by 10% or by 10% relative to the size of the second offset window 120. The vehicle based data processing system 110 can reduce the size of the second menu item 125 in a range from 5% to 75%. The vehicle based data processing system 110 can move the second menu item 125 from the center window 120 to the second offset window 120 or the third offset window 120. For example, the vehicle based data processing system 110 can move the second menu item 125 from the center window 120 to the second offset window 120 in response to a left motion input. The vehicle based data processing system 110 can move the second menu item 125 from the center window 120 to the third offset window 120 in response to a right motion input. The vehicle based data processing system 110 can increase a size of the first menu item 125 responsive to the motion input. The vehicle based data processing system 110 can increase the size of the first menu item 125 based in part on the size of the center window 120. For example, the vehicle based data processing system 110 can generate instructions to increase the size of the first menu item 125 by 10% or by 10% relative to the size of the center window 120. The vehicle based data processing system 110 can execute the instructions to increase the size of the first menu item 125 by 10% or by 10% relative to the size of the center window 120. The vehicle based data processing system 110 can increase the size of the first menu item 125 in a range from 5% to 75%. The vehicle based data processing system 110 can move the first menu item 125 from an offset window 120 (or a different window) to the center window 120. For example, the vehicle based data processing system 110 can move the first menu item 125 from the third offset window 120 to the center window 120 in response to a left motion input. The vehicle based data processing system 110 can move the first menu item 125 from the second offset window 120 to the center window 120 in response to a right motion input.

The sliders 145 can receive motion inputs at the same time or simultaneously to modify a size of menu items 125 provided within the windows 120 of the display module 115. For example, the first slider 145 and the second slider 145 can simultaneously receive the motion inputs. The motion inputs can be in opposite directions. For example, the first slider 145 can receive a first motion input in a first direction (e.g., a left swiping motion) and the second slider 145 can receive a second motion input in a second direction (e.g., a right swiping motion). The first slider 145 can generate a first motion signal corresponding to the first motion input (e.g., a left swiping motion) and the second slider 145 can generate a second motion signal corresponding to the second motion input (e.g., a right swiping motion). The vehicle based data processing system 110 can simultaneously receive the first motion signal corresponding to the first motion input from the first slider 145 and the second motion signal corresponding to the second motion input from the second slider 145. The vehicle based data processing system 110 can modify a size of a menu item 125 (e.g., first menu item, second menu item) provided within the center window 120 of the display module 115.

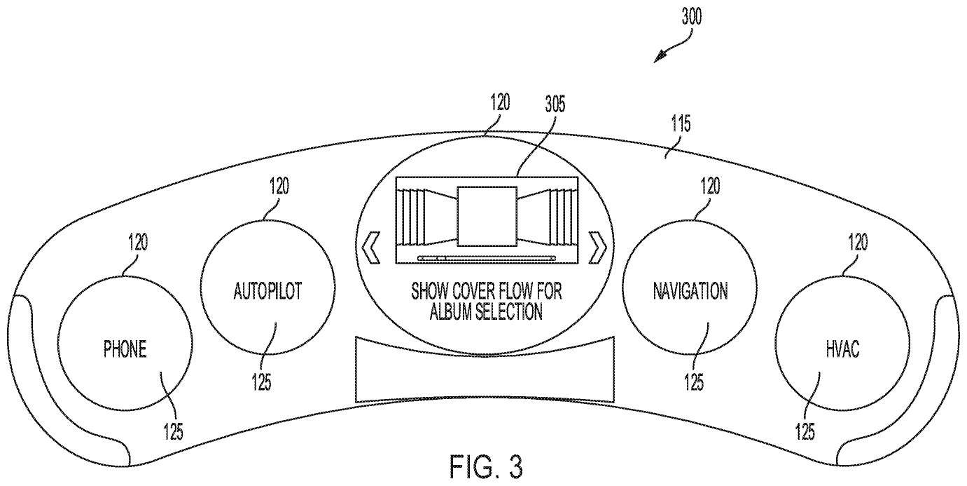

FIG. 3, among others, depicts a view 300 of a display module 115 having a plurality of windows 120. For example, and as depicted in FIG. 3, among others, the display module 115 can include a first offset window 120, a second offset window 120, a center window 120, a third offset window 120, and a fourth offset window 120. The first offset window 120, the second offset window 120, the third offset window 120, and the fourth offset window 120 can be referred to herein as offset windows 120 as they are positioned offset within the display module 115 as compared to the center window 120. For example, the first and second offset windows 120 may be offset in a first direction (e.g., left direction) as compared to a position of the center window 120. The third and fourth offset windows 120 may be offset in a second direction (e.g., right direction) as compared to a position of the center window 120. The vehicle based data processing system can generate each of the center window 120, the first offset window 120, the second offset window 120, the third offset window 120, and the fourth offset window 120 having a radius of curvature. For example, the vehicle based data processing system can generate the windows 120 having a circular shape. The vehicle based data processing system can generate the windows 120 having a spherical shape, octagonal shape, square shape, or rectangular shape.

The windows 120 can be generated by the vehicle based data processing system 110 having the same visibility with respect to a viewpoint of a user (e.g., driver, passenger) of the vehicle 107. One or more of the windows 120 can be generated by the vehicle based data processing system 110 having a different visibility as compared to one or more other windows 120 of the display module 115 with respect to a viewpoint of a user (e.g., driver, passenger) of the vehicle 107. For example, the center window 120 can have a first visibility. The first offset window 120, the second offset window 120, the third offset window 120, and the fourth offset window 120 can have a second visibility. The first visibility can be different from the second visibility. For example, the first visibility can be greater than the second visibility. Each of the windows 120 can be at least partially visible within a vehicle 107. For example, a portion of each of the windows 120 can be visible within the vehicle 107. The center window 120 can have a greater visibility as compared to the first, second, third, and fourth offset windows 120 within the vehicle 107. For example, a greater or larger portion of the center window 120 can be visible within the vehicle 107 as compared to the portions of the first, second, third, and fourth offset windows 120 visible within the vehicle 107.

The vehicle based data processing system 110 can generate or position the center window 120 between the second offset window 120 and the third offset window 120 (or between the first offset window 120 and the second offset window 120) such that a portion of the center window 120 partially overlaps a portion of the second offset window 120 and a portion of the center window 120 partially overlaps with a portion of the third offset window 120 (or a portion of the center window 120 partially overlaps a portion of the first offset window 120 and a portion of the center window 120 partially overlaps with a portion of the second offset window 120). The vehicle based data processing system 110 can generate or position the second offset window 120 between the center window 120 and the first offset window 120 such that a portion of the second offset window 120 partially overlaps with a portion the first offset window 120. The vehicle based data processing system 110 can generate or position the third offset window 120 between the center window 120 and the fourth offset window 120 such that a portion of the third offset window 120 partially overlaps with a portion the fourth offset window 120. The vehicle based data processing system 110 can generate or position the first offset window 120 between the center window 120 and the third offset window 120 such that a portion of the first offset window 120 partially overlaps with a portion the third offset window 120. The vehicle based data processing system 110 can generate or position the second offset window 120 between the center window 120 and the fourth offset window 120 such that a portion of the second offset window 120 partially overlaps with a portion the fourth offset window 120. The amount a window 120 partially overlaps another window 120 can vary based in part on the dimensions of the display module 115. For example, a window 120 (e.g., offset window, center window) can partially overlap half (e.g., 50%) of another window 120. A window 120 (e.g., offset window, center window) can partially overlap a quarter (e.g., 25%) of another window 120. The amount a window 120 partially overlaps another window 120 can range from 10% to 75%. The amount a window 120 partially overlaps another window 120 can vary within or outside this range.

The center window 120 can have different dimensions as compared to the first, second, third, and fourth offset windows 120 within the vehicle 107. For example, the center window 120 can be displayed more prominently within the display module 115 as compared to the first offset window 120, the second offset window 120, the third offset window 120, or the fourth offset window 120. For example, the center window 120 can have a greater diameter (or greater length and width) than a diameter of the first, second, third, and fourth offset windows 120. The center window 120 can have or be assigned a greater number of pixels as compared to the first offset window 120, the second offset window 120, the third offset window 120, or the fourth offset window 120. The vehicle based data processing system 110 can assign pixels to the multiple windows 120 of the display module 115 to increase a visibility or decrease a visibility of the respective window 120. For example, the vehicle based data processing system 110 can assign a first pixel value to the center window 120 and a second pixel value to the first, second, third, and fourth offset windows 120. The first pixel value can be greater than the second pixel value. The vehicle based data processing system 110 can assign a first pixel value to the center window 120, a second pixel value to the second and third offset windows 120, and a third pixel value to the first and fourth offset windows 120. The first pixel value can be greater than the second pixel value. The second pixel value can be greater than the third pixel value. The amount of pixels for the multiple windows 120 can vary and can be selected based at least in part on the dimensions of the display module 115. Each of the multiple windows 120 of the display module 115 can be assigned the same pixel value. One or more of the multiple windows 120 can be assigned a different pixel value from one or more of the other windows of the multiple windows of the display module 115.

The first, second, third, and fourth offset windows 120 can have the same dimensions (e.g., diameter, length, width). One or more of the first, second, third, and fourth offset windows 120 can have different dimensions (e.g., diameter, length, width) from one or more of the first, second, third, and fourth offset windows 120. For example, the windows 120 can be formed such that they increase in size and visibility as they transition to the center window 120. The first offset window 120 and the fourth offset window 120 can have the smallest diameter and visibility. The second offset window 120 and the third offset window 120 can have a greater diameter and visibility as compared to the first offset window 120 and the fourth offset window 120. The center window 120 can have a greater diameter and visibility as compared to the first, second, third and fourth offset windows 120. The first, second, third, and fourth offset windows 120 can be assigned or have the same pixel value (e.g., pixel amount). One or more of the first, second, third, and fourth offset windows 120 can have different pixel values from one or more of the first, second, third, and fourth offset windows 120. For example, the windows 120 can be formed such that they increase in pixel value and visibility as they transition to the center window 120. The first offset window 120 and the fourth offset window 120 can have the smallest pixel value and reduced visibility. The second offset window 120 and the third offset window 120 can have a greater pixel value and increased visibility as compared to the first offset window 120 and the fourth offset window 120. The center window 120 can have a greater pixel value and visibility as compared to the first, second, third and fourth offset windows 120.

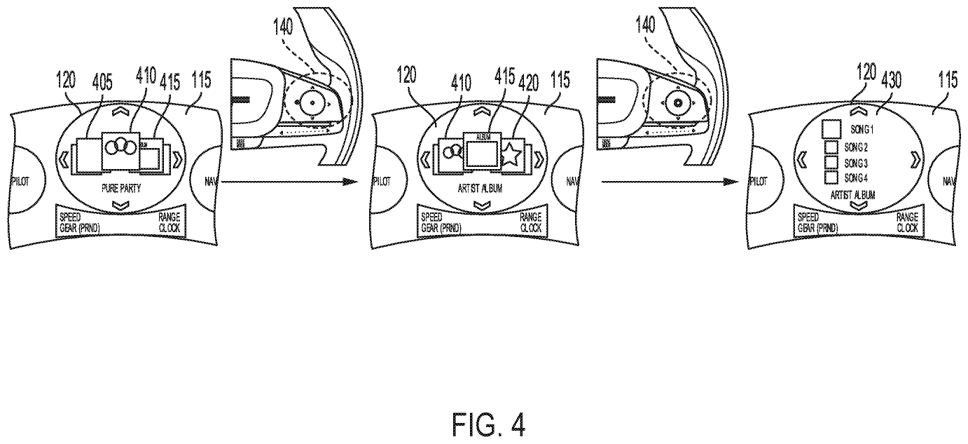

FIG. 4, among others, depicts a block diagram showing the transition of content within a center window 120 of a display module 115 for a consolidated instrument cluster 105 of a vehicle 107. In FIG. 4, a first offset window 120 displays content corresponding to a first menu item 125. By way of example, the first menu item 125 can correspond to an entertainment menu (e.g., music system) and thus, each of the content can correspond to different genres of music. In particular, the first offset window 120 display a first content 405, a second content 410, and a third content 415. The first content 405 can correspond to a first genre of music. The second content 410 can correspond to a second genre of music. The third content 405 can correspond to a third genre of music. The second content 410 can be displayed in a center portion of the first menu item 125. The second content 410 can be displayed between the first content 405 and the second content 415. The second content 410 can be displayed more prominently than the first content 405 or the third content 415. For example, the second content 410 can be displayed having larger dimensions or assigned a greater number of pixels such that the second content 410 is appears larger than the first content 405 or the third content 415 within the first menu item 125.

The vehicle based data processing system 110 can receive a first directional input from a first device input 140. The first directional input can correspond to a left input received through the first input device 140. Thus, the vehicle based data processing system 110 can transition the content 405, 410, 415 in the direction of the first directional input, here a left direction. The vehicle based data processing system 110 can identify instructions corresponding to the first direction input (or motion input) to relocate the content 405, 410, 415 in the direction of the first directional input. Responsive to the first directional input, the content 405, 410, 415 of the first menu item 125 is relocated by the vehicle based data processing system 110 in the left direction within the center window 120. For example, the second content 410 is displayed within a left portion of the center window 120. The third content 415 is displayed within a center portion of the center window 120. A fourth content 420 is displayed within a right portion of the center window 120. Thus, the third content 415 is disposed between the second content 410 and the fourth content 420 and the first content 405 of FIG. 4 is no longer displayed. With the third content 415 displayed within the center portion of the center window 120, the vehicle based data processing system 110 can receive a selection input through a center input of the first input device 140.

Responsive to the selection input, the vehicle based data processing system 110 can generate a selection panel 430 corresponding to the selected third content 415. For example, vehicle based data processing system 110 can provide the selection panel 430 corresponding to the third content 415 within the center window 120. The selection panel 430 can include a listing of content or selections corresponding to the third content 415. For example, the third content 415 can correspond to a genre of music and the selection panel 430 can include a selection of songs or listing of songs from the genre of music of the third content 415. The vehicle based data processing system 110 can generate the selection of songs or listing of songs provided within the selection panel 430. The vehicle based data processing system 110 can receive directional inputs from the first input device 140 to scroll through the selection panel 430 or otherwise interact with the selection panel 430 to select a song to play through an entertainment system of the vehicle 107.

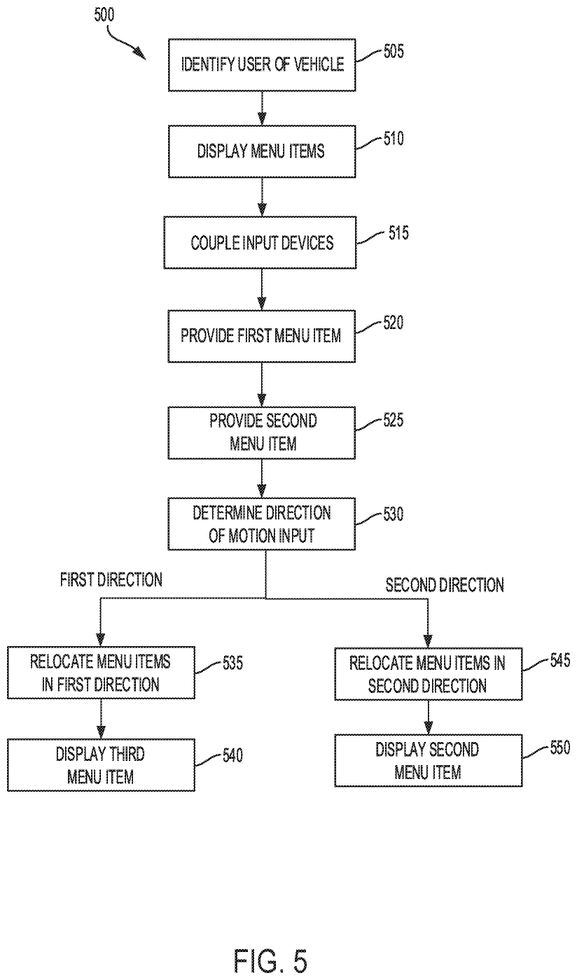

FIG. 5, among others, depicts a method 500 for providing content within a consolidated instrument cluster 105 of a vehicle 107. The method 500 can include identifying a user of the vehicle 107 (ACT 505). The vehicle 107 can include a consolidated instrument cluster 105 having a vehicle based data processing system 110. The vehicle based data processing system 110 can determine at least one user of the vehicle 107. For example, responsive to activating or turning on the vehicle or activating the consolidated instrument cluster 105, the vehicle based data processing system 110 can determine how many users are in the vehicle 107 and properties of the users (or user) in the vehicle 107. A user can refer to a driver or passenger in the vehicle 107. The vehicle based data processing system 110 can couple with one or more sensors within the vehicle to determine how many users are in the vehicle 107. For example, the seats in the vehicle can include sensors and the sensors can transmit a signal to the vehicle based data processing system 110 to indicate when a user is sitting in or on the respective seat. The vehicle based data processing system 110 can use the seat data to identify whether the user is a driver or passenger of the vehicle 107 or a combination of a driver and one or more passengers of the vehicle 107.

The vehicle based data processing system 110 can detect the presence or couple with one or more devices of a user of the vehicle 107 to detect the user of the vehicle 107. For example, the vehicle based data processing system 110 can detect the presence of a cell phone or hand held computing device and identify a user of the cell phone or hand held computing device. The vehicle based data processing system 110 can detect the presence of a key, electronic key, or key fob of the vehicle 107. The vehicle based data processing system 110 can use the device data to identify the corresponding user of the device. For example, the vehicle based data processing system 110 can receive user data from the device when the device couples with the consolidated instrument cluster 105. The vehicle based data processing system 110 can store user profiles and use the device data to identify the user of the respective device.

The method 500 can include displaying menu items (ACT 510). For example, the method 500 can include displaying, by the vehicle based data processing system 110, a plurality of menu items 125 within multiple windows 120 of a display module 115. The multiple windows 120 can include a center window 120. Each of the multiple windows 120 can be at least partially visible within the vehicle 107. The center window 120 of the multiple windows 120 can have greater visibility than other multiple windows 120 of the display module 115. The plurality of windows 120 can include two windows 120. The plurality of windows 120 can include more than two windows 120. The vehicle based data processing system 110 can generate the menu items 125 based on part of one or more users of the vehicle 107, a time of day, a location of the vehicle 107, or a device coupled with the vehicle based data processing system 110. For example, the menu items 125 can correspond to, for example, a climate control menu, an entertainment menu, an autonomous drive menu, a navigation menu, or a phone menu. The vehicle based data processing system 110 can display the menu items 125 within the plurality of windows 120 for the user or users of the vehicle 107 to interact with the menu items 125. Each of the windows 120 can display at least one menu item 125 of the plurality of menu items 125.

The method 500 can include coupling input devices (ACT 515). For example, the method 500 can include communicatively coupling a first input device 140, a second input device 140, a first slider 145, and a second slider 145 with the vehicle based data processing system 110. The input devices 140 and sliders 145 can communicatively couple with the vehicle based data processing system 110, for example, through a wireless connection. The input devices 140 and sliders 145 can couple with the vehicle based data processing system 110, for example, through a wired connection. The first and second input devices 140 can correspond to components of the consolidated instrument cluster 105. For example, the first and second input devices 140 can include buttons or keypads to generate a signal responsive to contact. The signals can correspond to a directional input or motion input to modify the menu items 125 displayed within the plurality of windows 120. The signals can include a direction (e.g., right, left, up, down) to slide a menu item 125 from a first offset window 120 to a second offset window 120. The signals (e.g., directional input s, motion inputs) can be provided to the vehicle based data processing system 110 from the respective input device 140. The first and second sliders 145 can correspond to components of the consolidated instrument cluster 105. For example, the first and second input sliders 145 can include a slide bar to generate a signal responsive to contact, such as but not limited to a swiping motion. The signals can correspond to a directional input or motion input to modify the menu items 125 displayed within the plurality of windows 120. The signals can include a direction (e.g., right, left, up, down) to slide a menu item 125 from a first offset window 120 to a second offset window 120. The signals (e.g., directional input s, motion inputs) can be provided to the vehicle based data processing system 110 from the respective slider 145.

The method 500 can include providing a first menu item 125 (ACT 520). For example, the method 500 can include displaying, by the vehicle based data processing system 110, a first menu item 125 of the plurality of menu items 125 in the center window 120. The vehicle based data processing system 110 can display at least one menu item 125 in the center window 120. The center window 120 having a greater visibility within the vehicle 107 than the other windows or offset windows 120 of the multiple windows of the display module 115. For example, the center window 120 can have a larger diameter or include more pixels than the other windows or offset windows 120 of the multiple windows of the display module 115. Providing the first menu item 125 can include selecting the first menu item 125 based in part on a relevance to the user or users of the vehicle 107. For example, the vehicle based data processing system 110 can identify and select the most relevant or most important menu item 125 to initially display in the center window 120. The vehicle based data processing system 110 can determine the relevance based at least in part on a frequency of use, time of day or properties of a user profile corresponding to the one or more users in the vehicle 107. For example, the vehicle based data processing system 110 can extract data from the user profile including the menu items 125 that the corresponding user interacts with the most. The user profile can include menu items for the particular user and the menu items can be ranked within the user profile based in part on frequency of use. The vehicle based data processing system 110 can extract the highest ranked or most used menu item 125 from the user profile and display the menu item 125 within the center window 120.

The method 500 can include providing second and third menu items 125 (ACT 525). For example, the method 500 can include displaying, by the vehicle based data processing system 110, a second menu item 125 of the plurality of menu items 125 in an offset window of the multiple windows 120. The method 500 can include displaying, by the vehicle based data processing system 110, a third menu item 125 of the plurality of menu items 125 in an offset window of the multiple windows 120. The offset window 120 can be a different window 120 from the center window 120 that is offset within the display module 115 with respect to the center window 120. The display module 115 can include multiple offset windows 120. For example, the display module 115 may include five windows 120 with two offset windows positioned to the left of the center window 120 and two windows 120 positioned to the right of the center window 120. The vehicle based data processing system 110 can display at least one menu item 125 in at least one offset window 120. The offset windows 120 can have a lesser visibility within the vehicle 107 as compared to the center window 120. The offset windows 120 can have a smaller diameter or less pixels as compared to the center window 120 to provide the lesser visibility. Providing the second and third menu items 125 can include selecting the second and third menu items 125 based in part on a relevance to the user or users of the vehicle 107. For example, the vehicle based data processing system 110 can extract data from the user profile including the menu items 125 that the corresponding user interacts with above a threshold point. The user profile can include menu items 125 for the particular user and the menu items 125 can be ranked within the user profile based in part on frequency of use. The vehicle based data processing system 110 can extract the one or more menu items 125 ranked above the threshold point and display the one or more menu items in offset windows 120 that are offset with respect to the center window 120. For example, the second menu item 125 can be displayed in an offset window 120 offset in a first direction or left direction from the center window 120. The third menu item 125 can be displayed in an offset window 120 offset in a second direction or right direction from the center window 120. Thus, the second menu item 125 can be offset in the first direction from the center window 120 and the third menu item 125 can be offset in the second direction from the center window 120.

The method 500 can include determining a direction or a motion input (ACT 530). For example, the method 500 can include receiving, by the vehicle based data processing system 110, a motion input through the first slider 145. The first motion input can indicate a first direction to relocate the plurality of menu items 125 within the multiple windows 120. For example, the consolidated instrument cluster 105 can include a first slider 145 and a second slider 145. The sliders 145 can receive a motion input through, for example, contact with a surface of the respective slider 145. The motion input may include, but not limited to, a swiping motion, a slide motion, or a pressing motion. Responsive to the motion input, the first slider 145 can generate a motion signal corresponding to a direction of the motion or contact with the surface of the first slider 145. The motion signal can include instructions for the vehicle based data processing system 110 to move, relocate or otherwise modify the menu items 125 displayed within the windows 120 of the display module 115. The vehicle based data processing system 110 can determine which slider 145 received the motion input or generated the motion signal. Responsive to the first motion input, the vehicle based data processing system 110 can identify a first instruction corresponding to the first motion input to relocate the first menu item 125 in the first direction from the center window 120 to the first offset window 120. For example, the first slider 145 can generate a first motion signal having instructions to scroll the menu items 125 displayed within the windows 120 of the display module 115 in a direction of the received motion. The first slider 145 can, responsive to a swipe in a left direction, can generate a motion signal to scroll the menu items 125 at least one window 120 to the left. The first slider 145 can, responsive to a swipe in a right direction, can generate a motion signal to scroll the menu items 125 at least one window 120 to the right. The vehicle based data processing system 110 can determine if the motion input is in a first direction or a second direction. The direction may include, but not limited to, left, right, up or down.

Responsive to a motion input in a first direction, the method 500 can include relocating the first menu item 125 in the first direction (ACT 535). For example, the method 500 an include reducing, by the vehicle based data processing system 110, a size of the first menu item 125 responsive to the motion input and relocating the first menu item 125 from the center window 120 to the first offset window 120 of the multiple windows 120. The vehicle based data processing system 110 can reduce the display size of the first menu item 125 to a size corresponding to the dimensions of the offset window 120 the first menu item is to be moved to. For example, the offset window 120 can have smaller dimensions than the center window 120. Thus, the vehicle based data processing system 110 can reduce the display size of the first menu item 125 such that the first menu item 125 fits within the dimension of the offset window 120. The first menu item 125 can be relocated to otherwise moved from the center window 120 to the first offset window or other offset window 120 adjacent to the center window 120 in the first direction. Responsive to the motion input in a left direction, the vehicle based data processing system 110 can relocate each of the menu items 125 displayed within the different windows 120 of the display module 115 in the left direction at least one window 120. For example, the first menu item 125 can be relocated from the center window 120 to the first offset window 120 positioned to the left of the center window 120 of the display module 115.

The method 500 can include displaying the third menu item 125 in the center window 120 (ACT 540). The vehicle based data processing system 110 can relocate each of the menu items 125 displayed within the different windows 120 of the display module 115 in the left direction at least one window 120, responsive to the motion input in a left direction. The vehicle based data processing system 110 can identify instructions to relocate each of the menu items 125 displayed within the different windows 120 of the display module 115 in the left direction at least one window 120. The third menu item 125 can be initially displayed in an offset window 120 positioned adjacent and to the right of the center window 120 (e.g., second offset window 120). Thus, responsive to the motion input in the left direction, the third menu item can be relocated from the right offset window 120 (or second offset window 120) to the center window 120 of the display module 120. The vehicle based data processing system 120 can increase a size of the third menu item responsive to the motion input. For example, the offset window 120 can have smaller dimensions than the center window 120. Thus, the vehicle based data processing system 110 can increase the display size of the third menu item 125 such that the third menu item 125 matches or fits the dimension of the center window 120. The vehicle based data processing system 110 can increase the display size of the third menu item 125 prior to relocating the third menu item 125 to the center window 120 or subsequent to relocating the third menu item 125 to the center window 120.

Responsive to a motion input in a second direction, the method 500 can include relocating the first menu item 125 in the second direction (ACT 545). The method 500 can include reducing, by the vehicle based data processing system 110, a size of the first menu item 125 responsive to the motion input and relocating the first menu item 125 from the center window 120 to the offset window 120 of the multiple windows 120. The vehicle based data processing system 110 can reduce the display size of the first menu item 125 to a size corresponding to the dimensions of the offset window 120 the first menu item is to be moved to. The vehicle based data processing system 110 can reduce the display size of the first menu item 125 such that the first menu item 125 fits within the dimension of the offset window 120. The first menu item 125 can be relocated to otherwise moved from the center window 120 to a second offset window 120 or other offset window 120 adjacent to the center window 120 in the second direction. Responsive to the motion input in a right direction, the vehicle based data processing system 110 can relocate each of the menu items 125 displayed within the different windows 120 of the display module 115 in the right direction at least one window 120. For example, the first menu item 125 can be relocated from the center window 120 to the second offset window 120 positioned to the right of the center window 120 of the display module 115.

The method 500 can include displaying the second menu item 125 in the center window 120 (ACT 550). The second menu item 125 can be initially displayed in an offset window 120 positioned adjacent and to the left of the center window 120 (e.g., first offset window 120). Thus, responsive to the motion input in the right direction, the second menu item can be relocated from the left offset window 120 (or first offset window 120) to the center window 120 of the display module 120. The vehicle based data processing system 120 can increase a size of the second menu item responsive to the motion input. For example, the first offset window 120 can have smaller dimensions than the center window 120. Thus, the vehicle based data processing system 110 can increase the display size of the second menu item 125 such that the second menu item 125 matches or fits the dimension of the center window 120. The vehicle based data processing system 110 can increase the display size of the second menu item 125 prior to relocating the second menu item 125 to the center window 120. The vehicle based data processing system 110 can increase the display size of the second menu item 125 subsequent to relocating the second menu item 125 to the center window 120.

The vehicle based data processing system 110 can, responsive to the first motion input, relocate each of the menu items 125 provided within offset windows 120. For example, vehicle based data processing system 110 can, responsive to the first motion input, relocate the third menu item 125 displayed within a third offset window from the third offset window to the first offset window in the first direction. The vehicle based data processing system 110 can, responsive to the first motion input, relocate a fourth menu item 125 displayed within the second offset window 120 from the second offset window 120 to a fourth first offset window 120 in the first direction. The vehicle based data processing system 110 can, responsive to the first motion input, remove a menu item 125 previously displayed in the first offset window 120 or third offset window 120. The vehicle based data processing system 110 can, responsive to the first motion input, generate a new menu item 125 for display in the fourth offset window 120.

The vehicle based data processing system 110 can receive directional inputs from the input devices 140 to interact with the menu item 125 displayed within the center window 120. For example, a directional input can be received through the first input device 140. The directional input can correspond to a first direction. The directional input can include up, down, left, right or center. The vehicle based data processing system 110 can modify content of the first menu item 125 in the first direction responsive to the directional input. For example, the vehicle based data processing system 110 can scroll the content of the first menu item 125 down responsive to a down directional input. The first menu item 125 may include a music system and the vehicle based data processing system 110 can scroll through, for example, but not limited to, a listing of songs in the direction of the directional input. The vehicle based data processing system 110 can receive a selection input from the input devices 140 to select the particular content of the menu item 125 displayed within the center window 120. For example, the first input device 140 can receive a selection input through a center portion of the first input device 140. The menu item 125 can include a navigation system and the selection content can include a desired destination. The first input device 140 can transmit the selection input to the vehicle based data processing system 110. The vehicle based data processing system 110 can activate the navigation system for the desired destination responsive to the selection input. The menu item 125 may include a phone system and the selection content can include a phone number. The first input device 140 can transmit the selection input to the vehicle based data processing system 110. The vehicle based data processing system 110 can activate the phone system and call the selected phone number responsive to the selection input. The menu item 125 may include a music system and the selection content can include a song. The first input device 140 can transmit the selection input to the vehicle based data processing system 110. The vehicle based data processing system 110 can activate the music system and play the selected song responsive to the selection input.

The vehicle based data processing system 110 can receive a second motion input through the second slider 145. The second motion input can be in a first or second direction (e.g., left, right). For example, responsive to the second motion input, the vehicle based data processing system 110 can identify an instruction corresponding to the second motion input to relocate the second menu item 125 in the second direction from the center window 120 to the first offset window 120. The vehicle based data processing system 110 can, responsive to the second motion input, identify an instruction corresponding to the second motion input to relocate the first menu item 125 in the second direction from the second offset window 120 to the center window 120. The vehicle based data processing system 110 reduce a size of the second menu item 125 or the third menu item 125 responsive to the second motion input. For example, the menu item 125 displayed within the center window 120 can be reduced to a size corresponding to the dimensions of an offset window in the first or second direction from the center window 120. The vehicle based data processing system 110 can move the second menu item 125 or the third menu item 125 from the center window 120 to the offset window 120 of the multiple windows 120. The menu item 125 can be moved to a right offset window 120 responsive to second motion input indicating a right motion. The menu item 125 can be moved to a left offset window 120 responsive to second motion input indicating a left motion. The vehicle based data processing system 110 can increase a size of the first menu item 125 responsive to the second motion input. For example, the first menu item 125 displayed within an offset window 120 can be increased to a size corresponding to the dimensions of the center window 120. The vehicle based data processing system 110 can move the first menu item 125 from the offset window 120 to the center window 120.

The vehicle based data processing system 110 can simultaneously receive the first motion input from the first slider 145 and a second motion input from the second slider 145. For example, the sliders 145 can receive motion inputs at the same time or simultaneously to modify a size of menu items 125 provided within the windows 120 of the display module 115. The motion inputs can be in opposite directions. For example, the first slider 145 can receive a first motion input in a first direction (e.g., a left swiping motion) and the second slider 145 can receive a second motion input in a second direction (e.g., a right swiping motion). The vehicle based data processing system 110 can receive a first motion signal generated by the first slider 145 corresponding to the first motion input (e.g., a left swiping motion) and a second motion signal generated by the second slider 145 corresponding to the second motion input (e.g., a right swiping motion). The vehicle based data processing system 110 can modify a size of a menu item 125 (e.g., first menu item, second menu item) provided within the center window 120 of the display module 115. For example, the vehicle based data processing system 110 may modify a size of the second menu item 125 provided within the center window 120 of the display module 115.

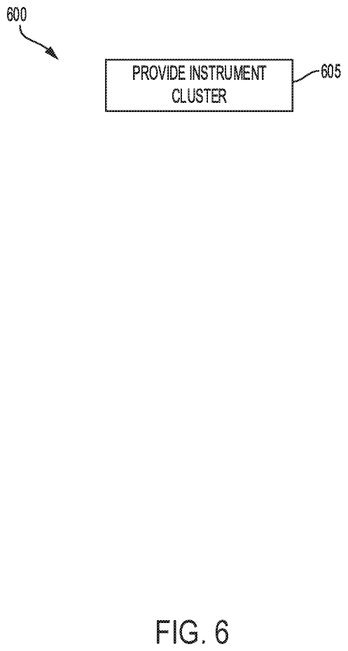

FIG. 6 depicts a method 600. The method 600 can include providing a consolidated instrument cluster 105 of a vehicle 107 (ACT 605). The consolidated instrument cluster 105 can include a vehicle based data processing system 110 communicatively coupled with a display module 115. The display module 115 can include multiple windows 120 to display a plurality of menu items 125. Each of the multiple windows 120 can display at least one menu item 125 of the plurality of menu items 125. The plurality of menu items 125 can include at least one of a climate control menu, an entertainment menu, an autonomous drive menu, a navigation menu, and a phone menu, for example. The multiple windows 120 can include a center window 120. Each of the multiple windows 120 can be at least partially visible within the vehicle 107. The center window 120 of the multiple windows 120 can have a greater visibility than other multiple windows 120 of the display module 115. The consolidated instrument cluster 105 can include a first input device 140, a second input device 140, a first slider 145, and a second slider 145. The vehicle based data processing system 110 can communicatively couple with the display module 115, the first input device 140, the second input device 140, the first slider 145, and the second slider 145. The vehicle based data processing system 110 to display a first menu item 125 of the plurality of menu items 125 in the center window 120 and a second menu item 125 of the plurality of menu items 125 in an offset window 120 of the multiple windows 120. The vehicle based data processing system 110 to receive a motion input through the first slider 145. The first motion input indicating a first direction to relocate the plurality of menu items 125 within the multiple windows 120. Responsive to the first motion input, the vehicle based data processing system 110 can identify a first instruction corresponding to the first motion input to relocate the first menu item 125 in the first direction from the center window 120 to a second offset window 120. Responsive to the first motion input, the vehicle based data processing system 110 can identify a second instruction corresponding to the first motion input to relocate the second menu item 125 in the first direction from the first offset window 120 to the center window 120. The vehicle based data processing system 110 to reduce a size of the first menu item 140 responsive to the motion input and relocate the first menu item 140 from the center window 120 to a second offset window 120 of the multiple windows 120. The vehicle based data processing system 110 to increase a size of the second menu item 125 responsive to the motion input and relocate the second menu item 125 from the first offset window 120 to the center window 120.

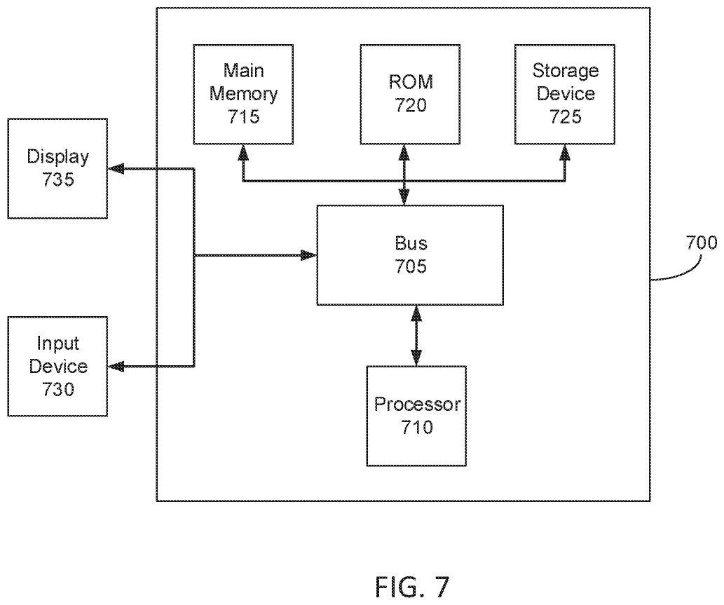

FIG. 7 is a block diagram of an example computer system 700. The computer system or computing device 700 can include or be used to implement the consolidated instrument cluster 105, or its components such as the data processing system 110 or display module 115. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory 114. The main memory 715 can also be used for storing menu items 125, position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the memory 114.

The computing system 700 may be coupled via the bus 705 to a display 735, such as a liquid crystal display, or active matrix display, for displaying information to a user such as a driver of the vehicle 107. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the consolidated instrument cluster 105, the display module 115, or windows 120, as well as part of the vehicle 107, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., display module 115), and the consolidated instrument cluster 105. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. The program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, the vehicle based data processing system can communicatively couple with more than one display module within a vehicle and generate multiple windows for each of the display modules. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A vehicle instrument cluster consolidation system, comprising:
a vehicle based data processing system having one or more processors communicatively coupled with a display module;
the display module having multiple windows to display a plurality of menu items;
each of the multiple windows displays at least one menu item of the plurality of menu items;
the plurality of menu items including at least one of a climate control menu, an entertainment menu, an autonomous drive menu, a navigation menu, and a phone menu;
the multiple windows including a center window, each of the multiple windows at least partially visible within a vehicle, the center window of the multiple windows having greater visibility than other multiple windows of the display module;
a first input device having multiple directional input buttons;
a second input device having multiple directional input buttons;
a first slider aligned with the first input device and the first slider disposed adjacent to at least one direction input button of the first input device;
a second slider aligned with the second input device and the second slider disposed adjacent to at least one direction input button of the second input device; and
the vehicle based data processing system communicatively coupled with the display module, first input device, second input device, first slider, and second slider, the vehicle based data processing system to:
provide for display a first menu item of the plurality of menu items in the center window and provide for display a second menu item of the plurality of menu items in a first offset window of the multiple windows;
receive a first motion input through the first slider, the first motion input indicates a first direction to relocate the plurality of menu items within the multiple windows;
responsive to the first motion input, identify a first instruction that corresponds to the first motion input to relocate the first menu item in the first direction from the center window to a second offset window;
responsive to the first motion input, identify a second instruction that corresponds to the first motion input to relocate the second menu item in the first direction from the first offset window to the center window;
responsive to the first instruction, reduce a size of the first menu item and relocate the first menu item from the center window to a second offset window of the multiple windows in the first direction; and
responsive to the second instruction, increase a size of the second menu item and relocate the second menu item from the first offset window to the center window in the first direction.

2. The system of claim 1, comprising:
the vehicle based data processing system to:
consolidate the display of the plurality of menu items into the display module, and the plurality of menu items correspond to different systems of the vehicle.

3. The system of claim 1, comprising:
the vehicle based data processing system to:
generate the display module having the center window, the first offset window, the second offset window, a third offset window, and a fourth offset window;
position the center window between the first offset window and the second offset window such that a first portion of the center window partially overlaps a first portion of the first offset window and a second portion of the center window partially overlaps with a first portion of the second offset window;
position the first offset window between the center window and the third offset window such that a second portion of the first offset window partially overlaps with a portion the third offset window; and
position the second offset window between the center window and the fourth offset window such that a second portion of the second offset window partially overlaps with a portion the fourth offset window.

4. The system of claim 1, comprising:
the vehicle based data processing system to:
responsive to the first motion input, relocate a third menu item displayed within a third offset window from the third offset window to the first offset window in the first direction; and
responsive to the first motion input, relocate a fourth menu item displayed within the second offset window from the second offset window to a fourth first offset window in the first direction.

5. The system of claim 1, comprising:
the vehicle based data processing system to:
generate each of the center window, the first offset window, the second offset window, a third offset window, and fourth offset window having a radius of curvature.

6. The system of claim 1, comprising:
the first input device and the second input device each comprise:
an up directional input button;
a down directional input button;
a left directional input button;
a right directional input button; and
a center directional input button.

7. The system of claim 1, comprising:
the first input device and the second input device each include multiple directional inputs, each of the multiple directional inputs corresponding to a different direction, and each of the multiple directional inputs generate at least one directional input to interact with at least one menu item provided within the center window of the display module.

8. The system of claim 1, comprising:
the vehicle based data processing system to:
receive a directional input through the first input device, the directional input corresponding to at least one direction; and
scroll content of the first menu item in the at least one direction responsive to the directional input.

9. The system of claim 1, comprising:
the first input device disposed at a first position on a steering wheel of the vehicle;
the first slider disposed at the first position on the steering wheel of the vehicle, the first slider disposed adjacent to the first input device, and the first slider positioned under a down input directional button of the first input device;
the second input device disposed at a second position on a steering wheel of the vehicle; and
the second slider disposed at the second position on the steering wheel of the vehicle, the second slider disposed adjacent to the second input device, and the first slider positioned under a down input directional button of the first input device;.

10. The system of claim 1, comprising:
the display module having a first offset window, a second offset window, the center window, a third offset window, and a fourth offset window, the center window having a first visibility, and the first offset window, the second offset window, the third offset window, and the fourth offset window having a second visibility, the first visibility greater than the second visibility.

11. The system of claim 1, comprising:
the vehicle based data processing system to:
receive a second motion input through the second slider, the second motion input indicating a second direction to relocate the plurality of menu items within the multiple windows;
responsive to the second motion input, identify a third instruction corresponding to the second motion input to relocate the second menu item in the second direction from the center window to the first offset window;
responsive to the second motion input, identify a fourth instruction corresponding to the second motion input to relocate the first menu item in the second direction from the second offset window to the center window;
responsive to the third instruction, reduce the size of the second menu item and relocate the second menu item from the center window to the first offset window of the multiple windows; and
responsive to the first instruction, increase the size of the first menu item and move the first menu item from the second offset window to the center window.

12. The system of claim 1, comprising:
the first slider coupled with the vehicle based data processing system to modify menu items provided within the multiple windows of the display module, responsive to a first motion input received via the first slider; and
the second slider coupled with the vehicle based data processing system to modify menu items provided within the multiple windows of the display module, responsive to a second motion input received via the second slider, the first motion input a different direction from the second motion input.

13. The system of claim 1, comprising:
the vehicle based data processing system to:
simultaneously receive the first motion input from the first slider and a second motion input from the second slider; and
modify a size of the second menu item provided within the center window of the display module.

14. The system of claim 1, comprising:
the display module having multiple windows disposed within a dashboard of the vehicle.

15. The system of claim 1, comprising:
the display module having multiple windows disposed within a console of the vehicle.

16. The system of claim 1, comprising:
the display module having multiple windows disposed within a steering wheel of the vehicle.

17. A method of consolidating vehicle instrument clusters of a vehicle, comprising:
displaying, by a vehicle based data processing system, a plurality of menu items within multiple windows of a display module, the multiple windows including a center window, each of the multiple windows displaying at least one menu item of the plurality of menu items, and each of the multiple windows at least partially visible within the vehicle, and the center window of the multiple windows having greater visibility than other multiple windows of the display module;
generating, by the vehicle based data processing system, the plurality of menu items including at least one of a climate control menu, an entertainment menu, an autonomous drive menu, a navigation menu, and a phone menu;
communicatively coupling a first input device having multiple directional input buttons, a second input device having multiple directional input buttons, a first slider, and a second slider with the vehicle based data processing system, the first slider aligned with the first input device and the first slider disposed adjacent to at least one direction input button of the first input device, and the second slider aligned with the second input device and the second slider disposed adjacent to at least one direction input button of the second input device;
displaying, by the vehicle based data processing system, a first menu item of the plurality of menu items in the center window;
displaying, by the vehicle based data processing system, a second menu item of the plurality of menu items in a first offset window of the multiple windows;
receiving, by the vehicle based data processing system, a first motion input through the first slider, the first motion input indicating a first direction to relocate the plurality of menu items within the multiple windows;
responsive to the first motion input, identifying, by the vehicle based data processing system, a first instruction that corresponds to the first motion input to relocate the first menu item in the first direction from the center window to a second offset window;
responsive to the first motion input, identifying, by the vehicle based data processing system, a second instruction that corresponds to the first motion input to relocate the second menu item in the first direction from the first offset window to the center window;
responsive to the first instruction, reducing, by the vehicle based data processing system, a size of the first menu item responsive to the first motion input and relocating the first menu item from the center window to a second offset window of the multiple windows; and
responsive to the second instruction increasing, by the vehicle based data processing system, a size of the second menu item responsive to the first motion input and relocating the second menu item from the first offset window to the center window.

18. The method of claim 17, comprising:
receiving, by the vehicle based data processing system, a second motion input through the second slider, the second motion input indicating a second direction to relocate the plurality of menu items within the multiple windows;
responsive to the second motion input, identifying, by the vehicle based data processing system, a third instruction corresponding to the second motion input to relocate the second menu item in the second direction from the center window to the first offset window;
responsive to the second motion input, identifying, by the vehicle based data processing system, a fourth instruction corresponding to the second motion input to relocate the first menu item in the second direction from the second offset window to the center window;
responsive to the third instruction, reducing, by the vehicle based data processing system, the size of the second menu item;
relocating, by the vehicle based data processing system, the second menu item from the center window to the first offset window of the multiple windows;
responsive to the fourth instruction, increasing, by the vehicle based data processing system, the size of the first menu item; and
relocating, by the vehicle based data processing system, the first menu item from the second offset window to the center window.

19. The method of claim 17, comprising:
simultaneously receiving, by the vehicle based data processing system, the first motion input from the first slider and a second motion input from the second slider; and
modifying, by the vehicle based data processing system, the size of the second menu item provided within the center window of the display module.

20. A vehicle, comprising:
a vehicle instrument cluster consolidation system, comprising:
a vehicle based data processing system communicatively coupled with a display module;
the display module having multiple windows to display a plurality of menu items;
each of the multiple windows displays at least one menu item of the plurality of menu items;
the plurality of menu items including at least one of a climate control menu, an entertainment menu, an autonomous drive menu, a navigation menu, and a phone menu;
the multiple windows including a center window, each of the multiple windows at least partially visible within a vehicle, the center window of the multiple windows having greater visibility than other multiple windows of the display module;
a first input device having multiple directional input buttons;
a second input device having multiple directional input buttons;
a first slider aligned with the first input device and the first slider disposed adjacent to at least one direction input button of the first input device;
a second slider aligned with the second input device and the second slider disposed adjacent to at least one direction input button of the second input device; and
the vehicle based data processing system communicatively coupled with the display module, first input device, second input device, first slider, and second slider, the vehicle based data processing system to:
provide for display a first menu item of the plurality of menu items in the center window and provide for display a second menu item of the plurality of menu items in a first offset window of the multiple windows;
receive a first motion input through the first slider, the first motion input indicates a first direction to relocate the plurality of menu items within the multiple windows;
responsive to the first motion input, identify a first instruction that corresponds to the first motion input to relocate the first menu item in the first direction from the center window to a second offset window;
responsive to the first motion input, identify a second instruction that corresponds to the first motion input to relocate the second menu item in the first direction from the first offset window to the center window;
responsive to the first instruction, reduce a size of the first menu item and relocate the first menu item from the center window to a second offset window of the multiple windows in the first direction; and
responsive to the second instruction, increase a size of the second menu item and relocate the second menu item from the first offset window to the center window in the first direction.
